(19) United States
(12) Patent Application Publication
(10) Pub. No.: US 2023/0229893 A1
(43) Pub. Date: Jul. 20, 2023

(54) COMPUTER-READABLE RECORDING MEDIUM STORING ABNORMALITY DETERMINATION PROGRAM, ABNORMALITY DETERMINATION DEVICE, AND ABNORMALITY DETERMINATION METHOD

(71) Applicant: FUJITSU LIMITED, Kawasaki-shi, Kanagawa (JP)

(72) Inventors: Yuichi KAMATA, Isehara (JP); Akira NAKAGAWA, Sagamihara (JP); Keizo KATO, Kawasaki (JP)

(73) Assignee: FUJITSU LIMITED, Kawasaki-shi, Kanagawa (JP)

(21) Appl. No.: 18/180,401

(22) Filed: Mar. 8, 2023

Related U.S. Application Data
(63) Continuation of application No. PCT/JP2020/035559, filed on Sep. 18, 2020.

(51) Int. Cl. G06N 3/0455

(52) U.S. Cl. CPC G06N 3/0455

(57) ABSTRACT

A recording medium stores a program for causing a computer to execute processing including: estimating a low-dimensional feature quantity with a lower dimensionality than input data obtained by encoding the input data as a conditional probability distribution using a condition based on data in a peripheral area of data of interest in the input data; and adjusting parameters of each of the encoding and the estimating and decoding of a feature quantity obtained by adding a noise to the low-dimensional feature quantity, based on a cost that includes output data obtained by the decoding, an error between the output data and the input data, and entropy of the conditional probability distribution. In determining whether input data to be determined is normal using the adjusted parameters, the determination is performed based on the conditional probability distribution based on data of a peripheral area of the input data to be determined.

### CROSS-REFERENCE TO RELATED APPLICATION

This application is a continuation application of International Application PCT/JP2020/035559 filed on Sep. 18, 2020 and designated the U.S., the entire contents of which are incorporated herein by reference.

### FIELD

The disclosed technique herein is related to an abnormality determination program, an abnormality determination device, and an abnormality determination method.

### BACKGROUND

In the past, it has been performed to detect abnormal data by training a probability distribution of normal data by unsupervised training and comparing a probability distribution of data to be determined with the probability distribution of the normal data.

Rate-Distortion Optimization Guided Autoencoder for Isometric Embedding in Euclidean Latent Space (ICML2020) and “Fujitsu Develops World's First AI technology to Accurately Capture Characteristics of High-Dimensional Data Without Labeled Training Data”, [online], Jul. 13, 2020, [Searched on Sep. 13, 2020], Internet <URL:https://www.fujitsu.com/global/about/resources/news/press-releases/2020/0713-01.html> are disclosed as related art.

### SUMMARY

According to an aspect of the embodiments, a non-transitory computer-readable recording medium stores an abnormality determination program for causing a computer to execute processing including: estimating a low-dimensional feature quantity with a lower dimensionality than input data obtained by encoding the input data as a conditional probability distribution using a condition based on data in a peripheral area of data of interest in the input data; and adjusting parameters of each of the encoding and the estimating and decoding of a feature quantity obtained by adding a noise to the low-dimensional feature quantity, based on a cost that includes output data obtained by the decoding, an error between the output data and the input data, and entropy of the conditional probability distribution. In determining whether input data to be determined is normal using the adjusted parameters, the determination is performed based on the conditional probability distribution based on data of a peripheral area of the input data to be determined.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing problems in a case of determining abnormality using a probability distribution of low-dimensional feature quantities;

FIG. 2 is a functional block diagram of an abnormality determination device;

FIG. 3 is a diagram for describing functions during training in a first embodiment;

FIG. 4 is a diagram for describing a peripheral area of a pixel of interest;

FIG. 5 is a diagram for describing a peripheral area of a pixel of interest;

FIG. 6 is a diagram for describing functions during determination in the first embodiment;

FIG. 7 is a block diagram illustrating a schematic configuration of a computer that functions as an abnormality determination device;

FIG. 8 is a flowchart illustrating an example of training processing in the first embodiment;

FIG. 9 is a flowchart illustrating an example of the determination processing in the first embodiment;

FIG. 10 is a diagram for describing functions during training in a second embodiment;

FIG. 11 is a diagram for describing functions during determination in the second embodiment;

FIG. 12 is a flowchart illustrating an example of training processing in the second embodiment; and

FIG. 13 is a flowchart illustrating an example of determination processing in the second embodiment.

### DESCRIPTION OF EMBODIMENTS

For example, techniques have been proposed, which obtain a probability distribution in a latent space proportional to a probability distribution in a real space by an autoencoder obtained by applying the rate-distortion theory that minimizes entropy of a latent variable, and detect abnormal data according to a difference in the probability distribution in the latent space.

However, in a case where features of the input data have various probability distributions, there is a problem that a feature of the probability distribution indicated by the abnormal data is buried in the difference between the various probability distributions, and normality or abnormality is not able to be accurately determined.

As one aspect, an object of the disclosed technique is to accurately determine normality or abnormality even in a case where features of input data have various probability distributions.

Hereinafter, examples of embodiments according to the disclosed technique will be described with reference to the drawings.

First, problem in a case where features of input data have various probability distributions in a case of determining normality or abnormality using a probability distribution indicating low-dimensional features extracted from the input data will be described before describing details of each embodiment.

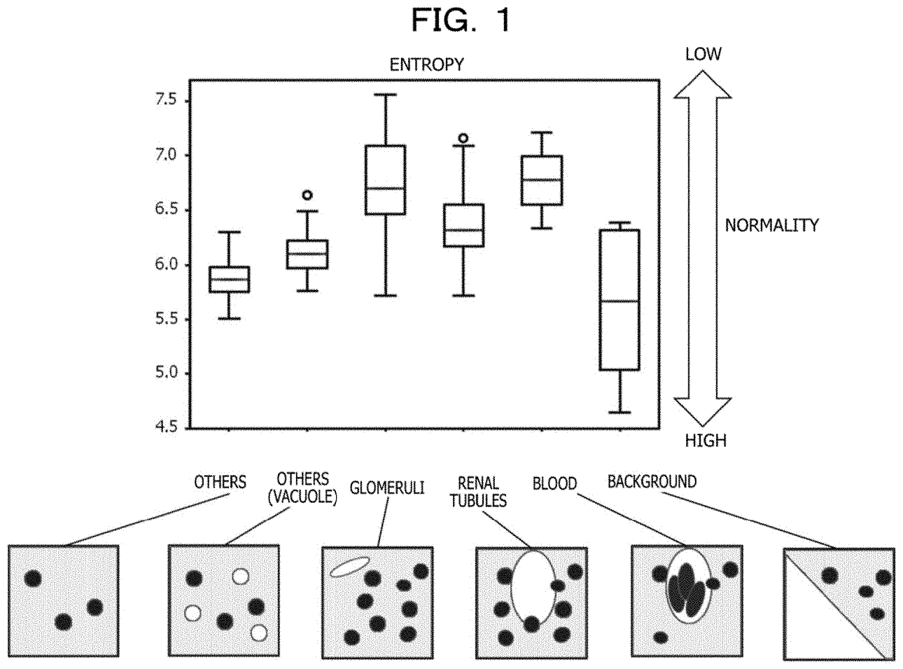

Here, an example of a case where the input data is a medical image obtained by capturing organs of a human body or the like. Examples of the medical image as the input data are schematically illustrated in the lower part of FIG. 1. In the example of FIG. 1, it is assumed that a state in which absence of vacuoles is determined to be normal, and presence of vacuoles is determined to be abnormal. In this case, entropy of low-dimensional features extracted from a medical image without vacuoles such as a medical image of “others” illustrated in FIG. 1 is used as a criterion, and entropy of low-dimensional features extracted from a target medical image is evaluated and normality or abnormality is determined. For example, as illustrated in the upper part of FIG. 1, it can be determined that a medical image of “others (vacuole)” is abnormal from a difference between the entropy of the “others” indicating normality and the entropy of the “others (vacuole)”.

However, as illustrated in the lower part of FIG. 1, medical images may contain tissues such as glomeruli, renal tubules, and blood, as well as a background, and high and low of entropy occurs depending on the tissues or background respectively included in the medical images. Therefore, in the case where the entropy of the “others” indicating normality is used as the criterion, the entropy of abnormal data is buried in the difference in the entropy for each tissue or the like as described above, and the normality or abnormality is not able to be determined with high accuracy.

Therefore, each of the following embodiments performs control to enable determination of normality or abnormality with high accuracy even in the case where probability distributions indicating low-dimensional features extracted from input data are various probability distributions.

### First Embodiment

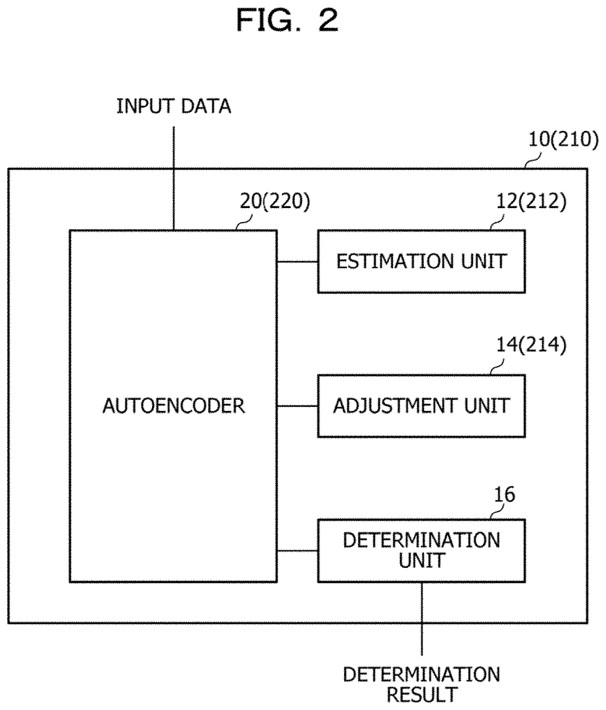

An abnormality determination device 10 according to a first embodiment functionally includes an autoencoder 20, an estimation unit 12, an adjustment unit 14, and a determination unit 16, as illustrated in FIG. 2. The estimation unit 12 and the adjustment unit 14 function during training of the autoencoder 20, and the estimation unit 12 and the determination unit 16 function during determination of abnormality using the autoencoder 20. Hereinafter, a more detailed configuration of the autoencoder 20 and the function of each functional unit will be described for each of during training and during determination.

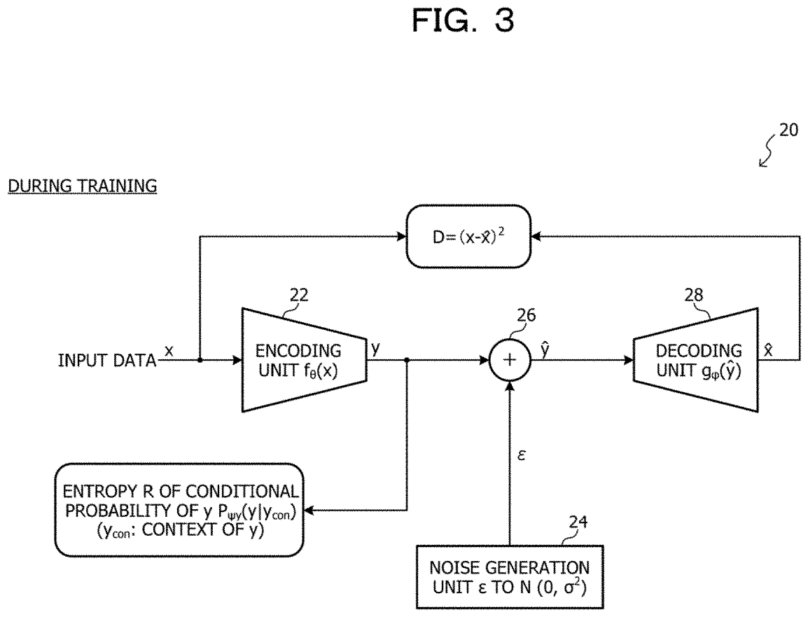

First, the functional units that function during training will be described with reference to FIG. 3.

The autoencoder 20 includes an encoding unit 22, a noise generation unit 24, an adding unit 26, and a decoding unit 28, as illustrated in FIG. 3.

The encoding unit 22 encodes multidimensional input data to extract a latent variable y, which is a low-dimensional feature quantity with a lower dimensionality than the input data. For example, the encoding unit 22 extracts the latent variable y from input data x using an encoding function f_{θ}(x) including a parameter θ. For example, the encoding unit 22 can apply a convolutional neural network (CNN) algorithm as the encoding function f_{θ}(x). The encoding unit 22 outputs the extracted latent variable y to the adding unit 26.

The noise generation unit 24 generates noise £ that is a random number based on a Gaussian distribution in which dimensionality is the same as that of the latent variable y and the respective dimensions are uncorrelated with each other, and a mean is 0 and variance is σ². The noise generation unit 24 outputs the generated noise ϵ to the adding unit 26.

The adding unit 26 adds the latent variable y input from the encoding unit 22 and the noise ϵ input from the noise generation unit 24 to generate a latent variable y\hat{ } (in the figure, “\hat{ }(hat)” is put on “y”) and outputs the latent variable y\hat{ } to the decoding unit 28.

The decoding unit 28 decodes the latent variable y\hat{ } input from the adding unit 26 to generate output data x\hat{ } (in the figure, “\hat{ } (hat)” is put on “x”) having the same dimensionality as the input data x. For example, the decoding unit 28 generates the output data x\hat{ } from the latent variable y\hat{ } using a decoding function g_{φ}(y\hat{ }) including a parameter cp. For example, the decoding unit 28 can apply a transposed CNN algorithm as the decoding function g_{φ}(y\hat{ }).

The estimation unit 12 acquires the latent variable y extracted by the encoding unit 22, and estimates the latent variable y as a conditional probability distribution under context of the latent variable y. The context in the present embodiment is related information about data of interest. For example, in a case where the input data is two-dimensional such as image data, the context is information held by data surrounding the data of interest, and in a case where the input data is one-dimensional time-series data, the context is information held by data before and after the data of interest.

For example, the estimation unit 12 extracts context y_{con} from the latent variable y using an extraction function h_{ψ2} including a parameter ψ2. Then, the estimation unit 12 estimates parameters μ_{(y)} and σ_{(y)} of a conditional probability distribution P_{ψy}(y|y_{con})=N(μ_{(y)}, σ_{(y)}²) of the latent variable y under the context y_{con}, the conditional probability distribution being represented by a multidimensional Gaussian distribution, using an extraction function h_{ψ1} including a parameter ψ1. To the extraction function h_{ψ2} and the estimation function h_{ψ1}, for example, an algorithm using an auto-regressive (AR) model such as a masked CNN can be applied. The AR model is a model that predicts a next frame from an immediately previous frame.

For example, in a case of using a masked CNN with a kernel size of 2k+1 (k is an arbitrary integer) in the case where the input data is image data, the estimation unit 12 estimates the parameters μ_{(y)} and σ_{(y)} using the following equation (1).

$$[ Math . 1 ]$$

$${}^{m , n} {μ}_{( y )} , {}^{m , n} {σ}_{( y )} = {h}_{ψ1} ( {}^{m , n} {y}_{con} ) = {h}_{ψ1} ( {h}_{ψ2} ( {}^{m - k , n - k} y , … , {}^{m - k , n + k} y , … , {}^{m , n - 1} y ) ) \qquad ( 1 )$$

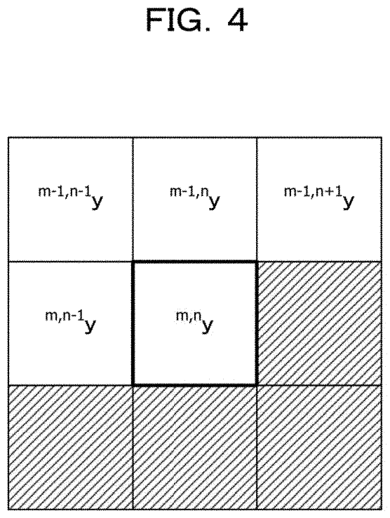

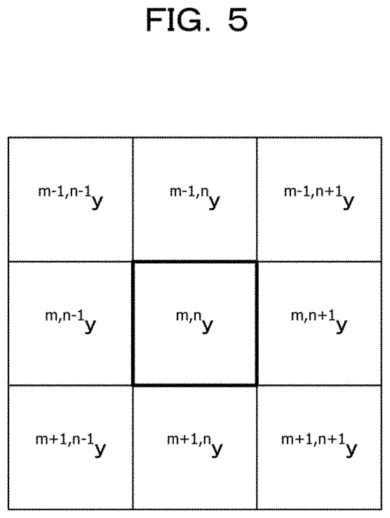

For example, in a case of k=1, the estimation unit 12 extracts information of pixels ^{m-1, n-1}y, ^{m-1, n}y, ^{m-1, n+1}y, and ^{m, n-1}y of a peripheral area of a pixel of interest ^{m, n}y, as the context, as illustrated in FIG. 4. Note that, as the peripheral area, the entire peripheral area of the pixel of interest ^{m, n}y may be used, as illustrated in FIG. 5.

Furthermore, the estimation unit 12 calculates entropy R=−log(P_{ψy}(y|y_{con})) of the conditional probability distribution P_{ψy}(y|y_{con}), using the estimated μ_{(y)} and σ_{(y)}. The equation (2) can also be used as another form of the entropy R calculation. Note that, in the equation (2), i is a variable that identifies each dimensional element (^{m, n}y in the example of the image data above) of the latent variable y.

$$[ Math . 2 ]$$

$$R = \frac{1}{2} {\sum }_{i} ( \frac{{( {μ}_{i ( y )} - {y}_{i} )}^{2}}{{σ}_{i ( y )}^{2} + {σ}^{2}} - log \frac{{σ}^{2}}{{σ}_{i ( y )}^{2} + {σ}^{2}} ) \qquad ( 2 )$$

The adjustment unit 14 adjusts each of the parameters θ, φ, ψ1, and ψ2 of the encoding unit 22, the decoding unit 28, and the estimation unit 12 based on a training cost including the error between the input data x and the output data x\hat{ } corresponding to the input data, and the entropy R calculated by the estimation unit 12. For example, the adjustment unit 14 repeats the processing of generating the output data x\hat{ } from the input data x while updating the parameters θ, φ, ψ1, and ψ2 so as to minimize a training cost L₁ represented by a weighted sum of the error between x and x\hat{ } and the entropy R, as illustrated in the following equation (3). Thereby, the parameters of the autoencoder 20 and the estimation unit 12 are trained.

[Math. 3]

L₁=E_{x˜p(x),ε}˜N(0,σ²)[R+λ·D] (3)

Note that, in the equation (3), λ is a weighting factor, and D is the error between x and x\hat{ }, for example, D=(x−x\hat{ })².

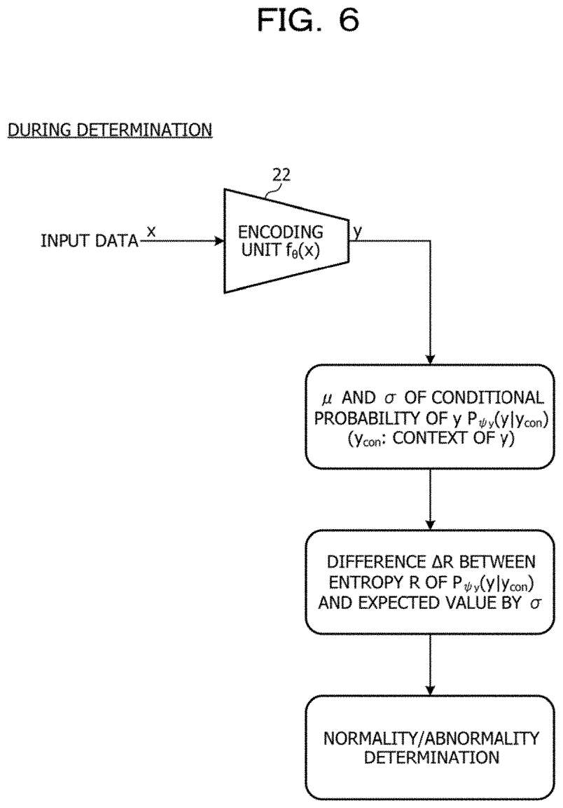

Next, functional units that function during determination will be described with reference to FIG. 6. Note that the input data during determination is an example of “input data to be determined” of the disclosed technique.

The encoding unit 22 extracts the latent variable y from the input data x by encoding the input data x based on the encoding function f_{θ}(x) to which the parameter θ adjusted by the adjustment unit 14 is set.

The estimation unit 12 acquires the latent variable y extracted by the encoding unit 22, and estimates the parameters μ_{(y)} and σ_{(y)} of the conditional probability distribution P_{ψy}(y|y_{con}) of the latent variable y, using the extraction function h_{ψ2} and the estimation function h_{ψ1} to which the parameters ψ1 and ψ2 adjusted by the adjustment unit 14 are set. Furthermore, the estimation unit 12 calculates a difference ΔR between the entropy R calculated from the estimated μ_{(y)} and σ_{(y)} by the equation (2) and an expected value of the entropy calculated from the estimated σ_{(y)}, using the following equation (4).

$$[ Math . 4 ]$$

$$Δ R = \frac{1}{2} {\sum }_{i} ( \frac{{( {μ}_{i ( y )} - {y}_{i} )}^{2} - {σ}_{i ( y )}^{2}}{{σ}_{i ( y )}^{2} + {σ}^{2}} ) \qquad ( 4 )$$

The determination unit 16 evaluates the entropy of the conditional probability distribution P_{ψy}(y|y_{con}) in determining whether the input data to be determined is normal, using the adjusted parameters θ, ψ1, and ψ2. For example, for the input data x to be determined, the determination unit 16 determines whether the input data x is normal or abnormal by comparing the difference ΔR of the entropy calculated by the estimation unit 12 with a predetermined determination criterion, and outputs a determination result. The determination criterion can be determined experimentally or empirically.

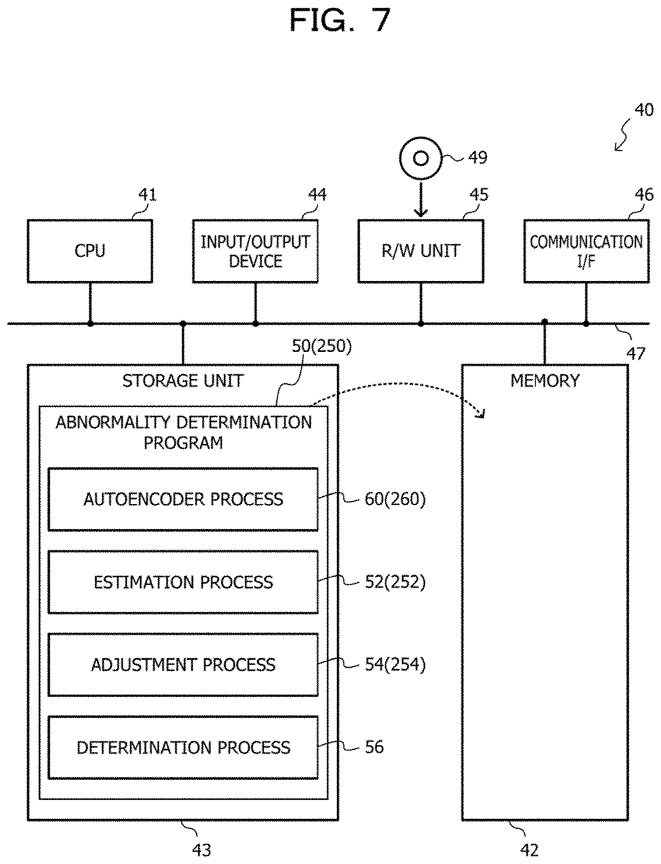

The abnormality determination device 10 can be implemented by, for example, a computer 40 illustrated in FIG. 7. The computer 40 includes a central processing unit (CPU) 41, a memory 42 as a temporary storage area, and a nonvolatile storage unit 43. Furthermore, the computer 40 includes an input/output device 44 such as an input unit or a display unit, and a read/write (R/W) unit 45 that controls reading and writing of data from/to a storage medium 49. Furthermore, the computer 40 includes a communication interface (I/F) 46 to be connected to a network such as the Internet. The CPU 41, the memory 42, the storage unit 43, the input/output device 44, the R/W unit 45, and the communication I/F 46 are coupled to one another via a bus 47.

The storage unit 43 may be implemented by a hard disk drive (HDD), a solid state drive (SSD), a flash memory, or the like. The storage unit 43 as a storage medium stores an abnormality determination program 50 for causing the computer 40 to function as the abnormality determination device 10 to execute training processing and determination processing, which will be described below. The abnormality determination program 50 has an autoencoder process 60, an estimation process 52, an adjustment process 54, and a determination process 56.

The CPU 41 reads the abnormality determination program 50 from the storage unit 43, expands the abnormality determination program 50 on a memory 42, and sequentially executes the processes included in the abnormality determination program 50. The CPU 41 operates as the autoencoder 20 illustrated in FIG. 2 by executing the autoencoder process 60. Furthermore, the CPU 41 operates as the estimation unit 12 illustrated in FIG. 2 by executing the estimation process 52. Furthermore, the CPU 41 operates as the adjustment unit 14 illustrated in FIG. 2 by executing the adjustment process 54. Furthermore, the CPU 41 executes the determination process 56, thereby operating as the determination unit 16 illustrated in FIG. 2. With this configuration, the computer 40 that has executed the abnormality determination program 50 functions as the abnormality determination device 10. Note that the CPU 41 that executes the program is hardware.

Note that functions implemented by the abnormality determination program 50 may also be implemented by, for example, a semiconductor integrated circuit, for example, an application specific integrated circuit (ASIC) or the like.

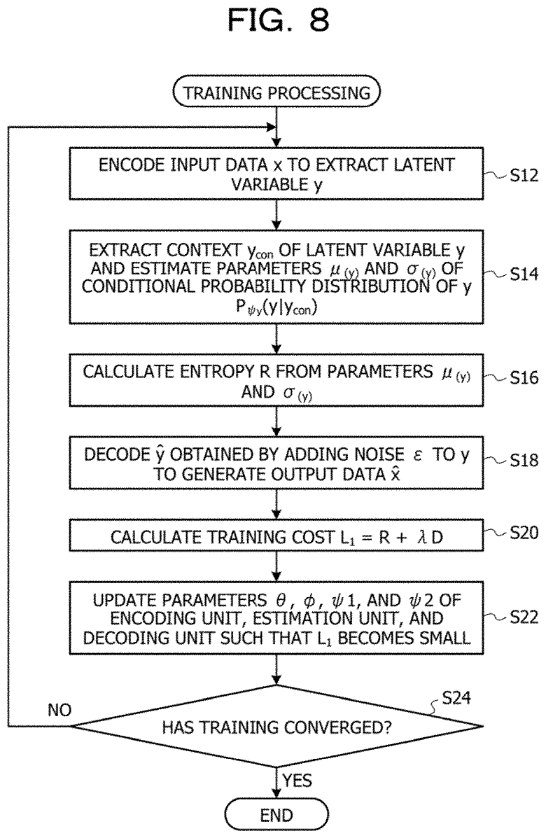

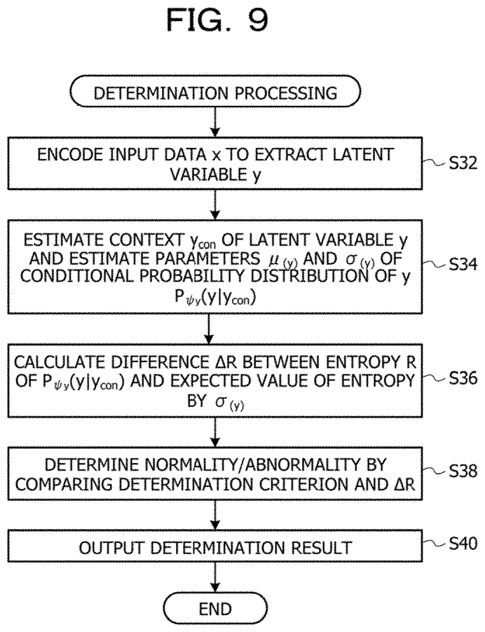

Next, function and operation of the abnormality determination device 10 according to the first embodiment will be described. When the input data x for training is input to the abnormality determination device 10 during adjustment of the parameters of the autoencoder 20 and the estimation unit 12, the abnormality determination device 10 executes training processing illustrated in FIG. 8. Furthermore, when the input data x to be determined is input to the abnormality determination device 10 during determination of normality or abnormality, the abnormality determination device 10 executes determination processing illustrated in FIG. 9. Note that the training processing and the determination processing are examples of an abnormality determination method of the disclosed technique.

First, the training processing will be described in detail with reference to FIG. 8.

In step S12, the encoding unit 22 extracts the latent variable y from the input data x using the encoding function fₑ(x) including the parameter θ, and outputs the extracted latent variable y to the adding unit 26.

Next, in step S14, the estimation unit 12 extracts the context y_{con} of the latent variable y from the latent variable y using the extraction function h_{ψ2} including the parameter ψ2. Then, the estimation unit 12 estimates the parameters μ_{(y)} and σ_{(y)} of the conditional probability distribution P_{ψy}(y|y_{con}) of the latent variable y under the context y_{con} by the estimation function h_{ψ1} including the parameter ψ1.

Next, in step S16, the entropy R=−log(R_{ψy}(y|y_{con})) of the conditional probability distribution P_{ψy}(y|y_{con}) is calculated by the equation (2), using the estimated μ_{(y)} and σ_{(y)}.

Next, in step S18, the noise generation unit 24 generates noise ε that is a random number based on a Gaussian distribution in which the dimensionality is the same as that of the latent variable y and respective dimensions are uncorrelated with each other, and a mean is 0 and variance is σ², and outputs the noise ε to the adding unit 26. Then, the adding unit 26 adds the latent variable y input from the encoding unit 22 and the noise ε input from the noise generation unit 24 to generate a latent variable y\hat{ } and outputs the latent variable y\hat{ } to the decoding unit 28. Moreover, the decoding unit 28 decodes the latent variable y\hat{ } using the decoding function g_{φ}(y\hat{ }) including the parameter φ to generate the output data x\hat{ }.

Next, in step S20, the adjustment unit 14 calculates the error between the input data x and the output data x\hat{ } generated in step S18 above as, for example, D=(x−x\hat{ })². Then, the adjustment unit 14 calculates the training cost L₁ represented by the weighted sum of the calculated error D and the entropy R calculated by the estimation unit 12 in step S16 above, as illustrated in the equation (3), for example.

Next, in step S22, the adjustment unit 14 updates the parameter θ of the encoding unit 22, the parameter φ of the decoding unit 28, and the parameters ψ1 and ψ2 of the estimation unit 12 such that the training cost L₁ becomes small.

Next, in step S24, the adjustment unit 14 determines whether the training has converged. For example, it can be determined that the training has converged in a case where the number of repetitions of the parameter update has reached a predetermined number, in a case where the value of the training cost L₁ remains unchanged, or the like. In a case where the training has not converged, the processing returns to step S12, and the processing of steps S12 to S22 is repeated for the next input data x. In a case where the training has converged, the training processing ends.

Next, the determination processing will be described in detail with reference to FIG. 9. The determination processing is started in the state where each of the parameters θ, ψ1, and ψ2 adjusted by the training processing is set in each of the encoding unit 22 and the estimation unit 12.

In step S32, the encoding unit 22 extracts the latent variable y from the input data x using the encoding function fₑ(x) including the adjusted parameter θ.

Next, in step S34, the estimation unit 12 extracts the context y_{con} of the latent variable y from the latent variable y using the extraction function h_{ψ2} including the adjusted parameter ψ2. Then, the estimation unit 12 estimates the parameters μ_{(y)} and σ_{(y)} of the conditional probability distribution P_{ψy}(y|y_{con}) of the latent variable y under the context y_{con} by the estimation function h_{ψ1} including the adjusted parameter ψ1.

Next, in step S36, the estimation unit 12 calculates the difference ΔR between the entropy R calculated from the estimated μ_{(y)} and σ_{(y)} by the equation (2) and an expected value of the entropy calculated from the estimated σ_{(y)}, using the following equation (4).

Next, in step S38, the determination unit 16 determines whether the input data x is normal or abnormal by comparing the difference ΔR of the entropy calculated by the estimation unit 12 in step S36 above with the predetermined determination criterion.

Next, in step S40, the determination unit 16 outputs a determination result as to whether the data is normal or abnormal, and the determination processing ends.

As described above, the abnormality determination device according to the first embodiment estimates the latent variable with a lower dimensionality than the input data, the latent variable being obtained by encoding the input data, as the conditional probability distribution under the context representing broad features of the input data. The context is information of the peripheral data of the data of interest of the latent variable. Furthermore, the abnormality determination device adjusts each of the parameters of the encoding, estimation, and decoding based on the cost including the error between the output data obtained by decoding the feature quantity obtained by adding the noise to the latent variable and the input data, and the entropy of the conditional probability distribution. Then, the abnormality determination device evaluates the entropy of the conditional probability distribution in determining whether the input data to be determined is normal, using the adjusted parameters. Thereby, it becomes possible to evaluate the local features indicated by the latent variable under the broad features indicated by the context of the latent variable and determine the normality or abnormality. For example, it is possible to evaluate the local features of the latent variable under the condition by the features according to the type (type of a tissue or the like in the example of FIG. 1) of the input data, using the broad features of the latent variable. Therefore, even in the case where the features of the input data have various probability distributions and the difference between normality and abnormality is in the local features, it is possible to suppress a difficulty in distinguishing the normality and abnormality and to accurately determine the normality or abnormality.

### Second Embodiment

Next, a second embodiment will be described. Note that, in an abnormality determination device according to the second embodiment, detailed description of parts common to the abnormality determination device 10 according to the first embodiment will be omitted.

An abnormality determination device 210 according to the second embodiment functionally includes an autoencoder 220, an estimation unit 212, an adjustment unit 214, and a determination unit 16, as illustrated in FIG. 2. The estimation unit 212 and the adjustment unit 214 function during training of the autoencoder 220, and the estimation unit 212 and the determination unit 16 function during determination of abnormality using the autoencoder 220. Hereinafter, a more detailed configuration of the autoencoder 220 and the function of each functional unit will be described for each of during training and during determination.

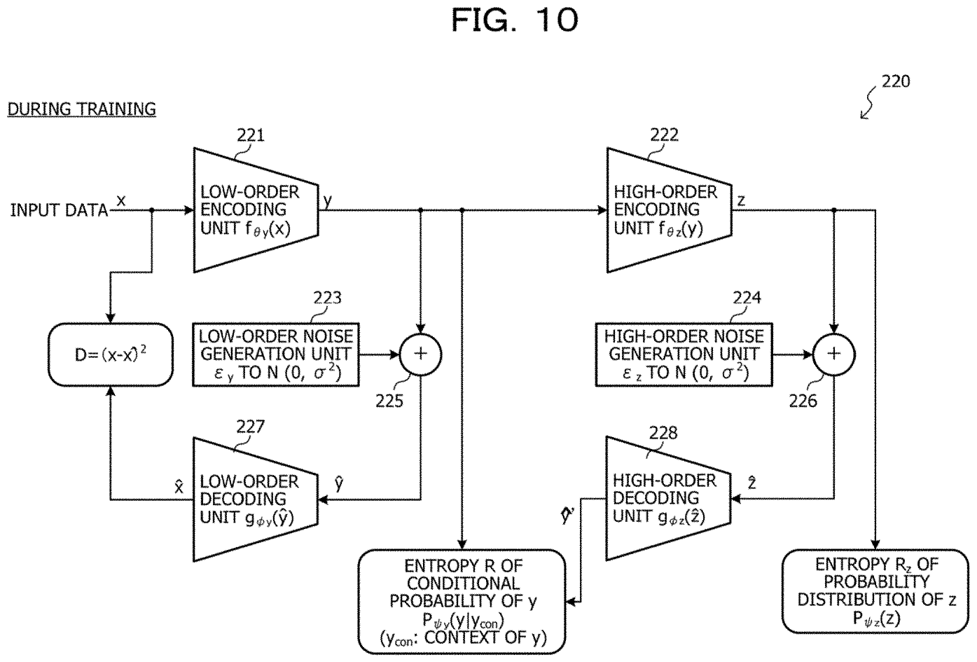

First, functional units that function during training will be described with reference to FIG. 10.

As illustrated in FIG. 10, the autoencoder 220 includes a low-order encoding unit 221, a high-order encoding unit 222, a low-order noise generation unit 223, a high-order noise generation unit 224, a low-order adding unit 225, a high-order adding unit 226, a low-order decoding unit 227, and a high-order decoding unit 228.

The low-order encoding unit 221 extracts a low-order latent variable y from input data x using an encoding function f_{θy}(x) including a parameter θy. The low-order latent variable y represents local features of the input data. The low-order encoding unit 221 outputs the extracted low-order latent variable y to the low-order adding unit 225 and the high-order encoding unit 222. The high-order encoding unit 222 extracts a lower-dimensional high-order latent variable z from the low-order latent variable y using an encoding function f_{θz}(y) including a parameter Oz. The high-order latent variable z represents broad features of the input data. The high-order encoding unit 222 outputs the extracted low-order latent variable z to the high-order adding unit 226. A CNN algorithm can be applied as the encoding functions f_{θy}(x) and f_{θz}(y).

The low-order noise generation unit 223 generates noise ε_{y} having the same dimensionality as the low-order latent variable y, and outputs the noise ε_{y} to the low-order adding unit 225. The high-order noise generation unit 224 generates noise ε_{z} having the same dimensionality as the high-order latent variable z, and outputs the noise ε_{z} to the high-order adding unit 226. The noises ε_{y} and ε_{z} are random numbers based on a Gaussian distribution in which the respective dimensions are uncorrelated with each other, and a mean is 0 and variance is σ².

The low-order adding unit 225 adds the low-order latent variable y input from the low-order encoding unit 221 and the noise ε_{y} input from the low-order noise generation unit 223 to generate the low-order latent variable y\hat{ } and outputs the low-order latent variable y\hat{ } to the low-order decoding unit 227. The high-order adding unit 226 adds the high-order latent variable z input from the high-order encoding unit 222 and the noise ε_{z} input from the high-order noise generation unit 224 to generate a high-order latent variable z\hat{ } (in the figure, “\hat{ } (hat)” is put on “z”), and outputs the high-order latent variable z\hat{ } to the high-order decoding unit 228.

The low-order decoding unit 227 decodes the low-order latent variable y\hat{ } input from the low-order adding unit 225 using a decoding function g_{φy}(y\hat{ }) including a parameter φy to generate a low-order output data x\hat{ } having the same dimensionality as the input data x. The high-order decoding unit 228 decodes the high-order latent variable z\hat{ } input from the high-order adding unit 226 using a decoding function g_{φz}(z\hat{ }) including a parameter φz to generate high-order output data y\hat{ }′ having the same dimensionality as the low-order latent variable y. A transposed CNN algorithm can be applied as the decoding functions g_{φy}(z\hat{ }) and g_{φz}(z\hat{ }).

The estimation unit 212 acquires the high-order latent variable z extracted by the high-order encoding unit 222, and estimates the high-order latent variable z as a probability distribution. For example, the estimation unit 212 estimates a probability distribution P_{φz}(z) using a probability distribution model including a parameter φz in which a plurality of distributions is mixed. In the present embodiment, a case where the probability distribution model is a Gaussian mixture model (GMM) will be described. In this case, the estimation unit 212 estimates the probability distribution P_{φz}(z) by calculating parameters π, Σ, and μ in the following equation (5) using a maximum likelihood estimation method or the like.

$$[ Math . 5 ]$$

$${P}_{ψ z} ( z ) = {\sum }_{k = 1}^{K} {π}_{k} \frac{exp ( - \frac{1}{2} {( z - {μ}_{k} )}^{T} {{Σ}_{k}}^{- 1} ( z - {μ}_{k} ) )}{\sqrt{‖ 2 {πΣ}_{k} \vert}} \qquad ( 5 )$$

In the equation (5), K is the number of normal distributions included in the GMM, μₖ is a mean vector of the k-th normal distribution, Σₖ is a variance-covariance matrix of the k-th normal distribution, πₖ is a weight of the k-th normal distribution (mixing coefficient), and a sum of πₖ is 1. Furthermore, the estimation unit 212 calculates entropy R_{z}=−log(R_{ψz}(z)) of the probability distribution R_{ψz}(z).

Furthermore, the estimation unit 212 estimates the low-order latent variable y as a conditional probability distribution P_{ψy}(y|y_{con}) under context y_{con} of the low-order latent variable y, similarly to the estimation unit 12 in the first embodiment. In the second embodiment, context extracted from the high-order output data y\hat{ }′ outputted from the high-order decoding unit 228 is also used in addition to information of peripheral data of data of interest of the low-order latent variable y.

For example, the estimation unit 212 extracts a context y_{con} from the low-order latent variable y and the high-order output data y\hat{ }′ using an extraction function h_{ψ2y} including a parameter ψ2y. Then, the estimation unit 212 estimates parameters μ_{(y)} and σ_{(y)} of a conditional probability distribution P_{ψy}(y|y_{con}) of the low-order latent variable y under the context y_{con}, the conditional probability distribution being represented by a multidimensional Gaussian distribution, using an extraction function h_{ψ1y} including a parameter ψ1y.

For example, in a case of using a masked CNN with a kernel size of 2k+1 (k is an arbitrary integer) in the case where the input data is image data, the estimation unit 212 estimates the parameters μ_{(y)} and σ_{(y)} using the following equation (6).

$$[ Math . 6 ]$$

$${}^{m , n} {μ}_{( y )} , {}^{m , n} {σ}_{( y )} = {h}_{ψ1y} ( {}^{m , n} {y}_{con} ) = {h}_{ψ1y} ( {h}_{ψ2y} ( {}^{m - k , n - k} y , … , {}^{m - k , n + k} y , … , {}^{m , n - 1} y , {}^{m - k , n - k} {\hat{y}}^{′} , … , {}^{m - k , n + k} {\hat{y}}^{′} , … , {}^{m , n - 1} {\hat{y}}^{′} ) ) \qquad ( 6 )$$

Furthermore, the estimation unit 212 calculates entropy R_{y}=−log(P_{ψy}(y|y_{con})) of the conditional probability distribution P_{ψy}(y|y_{con}) by the equation (2), using the estimated μ_{(y)} and σ_{(y)}, similarly to the estimation unit 12 in the first embodiment.

The adjustment unit 214 calculates a training cost L₂ including the error between the input data x and the output data x\hat{ } corresponding to the input data, and the entropy R_{z} and the entropy R_{y} calculated by the estimation unit 212. The adjustment unit 214 adjusts each of the parameters θy, θz, φy, φz, ψz, ψ1y, and ψ2y of the low-order encoding unit 221, the high-order encoding unit 222, the low-order decoding unit 227, the high-order decoding unit 228, and the estimation unit 212 based on the training cost L₂. For example, the adjustment unit 214 repeats the processing of generating the output data x\hat{ } from the input data x while updating the parameters θy, θz, φy, φz, ψz, ψ1y, and ψ2y so as to minimize the training cost L₂ represented by a weighted sum of the error D between x and x\hat{ } and the entropy R_{z} and the entropy R_{y}, as illustrated in the following equation (7). Thereby, the parameters of the autoencoder 220 and the estimation unit 212 are trained.

[Math. 7]

L₂=E_{x˜p(x),ε}_{_{z}}_{˜N(0,σ}_{²}_{),ε}_{_{y}}_{˜N(0,σ}_{²}₎[R_{z}+R_{y}+λ·S] (7)

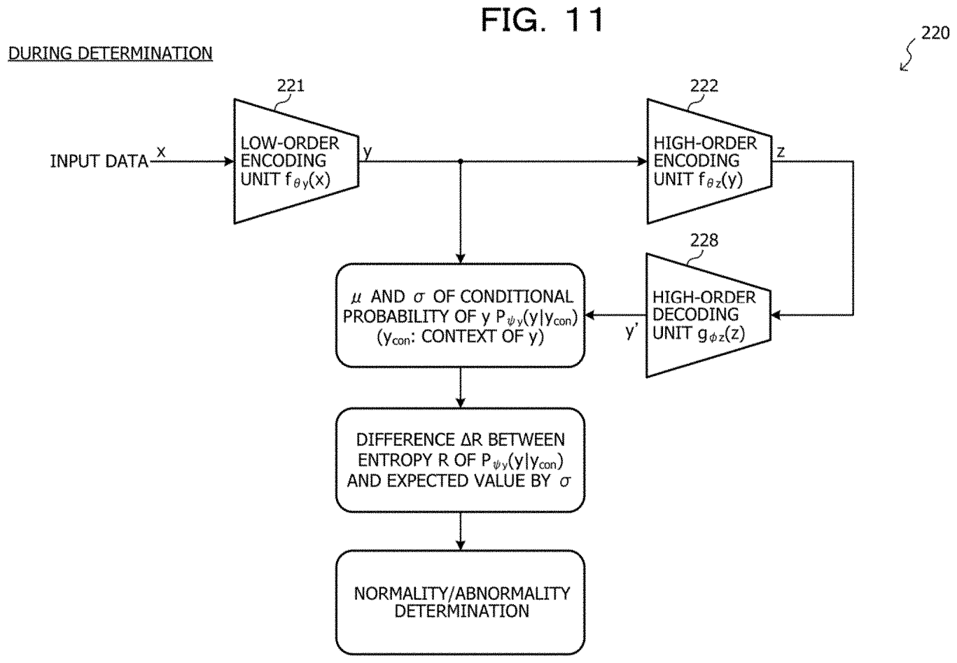

Next, functional units that function during determination will be described with reference to FIG. 11.

The low-order encoding unit 221 extracts the low-order latent variable y from the input data x by encoding the input data x based on the encoding function f_{θy}(x) to which the parameter θy adjusted by the adjustment unit 214 is set, and inputs the low-order latent variable y to the high-order encoding unit 222.

The high-order encoding unit 222 extracts the high-order latent variable z from the low-order latent variable y by encoding the low-order latent variable y based on the encoding function f_{θz}(y) to which the parameter θz adjusted by the adjustment unit 214 is set, and inputs the high-order latent variable z to the high-order decoding unit 228.

The high-order decoding unit 228 decodes the high-order latent variable z input from the high-order encoding unit 222 using the decoding function g_{φz}(z) including the parameter φz adjusted by the adjustment unit 214 to generate the high-order output data y′ having the same dimensionality as the low-order latent variable y.

The estimation unit 212 acquires the low-order latent variable y extracted by the low-order encoding unit 221 and the high-order output data y′ generated by the high-order decoding unit 228. Then, the estimation unit 212 extracts a context y_{con} from the latent variable y and the high-order output data y\hat{ }′ using an extraction function h_{ψ2y} including a parameter ψ2y adjusted by the adjustment unit 214. Furthermore, the estimation unit 212 estimates parameters μ_{(y)} and σ_{(y)} of a conditional probability distribution P_{ψy}(y|y_{con}) of the latent variable y under the context y_{con}, the conditional probability distribution being represented by a multidimensional Gaussian distribution, using an extraction function h_{ψ1y} including a parameter ψ1y. Note that, during determination, the estimation unit 212 estimates the parameters μ_{(y)} and σ_{(y)} using an equation in which “y\hat{ }” in equation (6) is replaced with “y′”.

Furthermore, the estimation unit 212 calculates a difference ΔR between the entropy R_{y} calculated from the estimated μ_{(y)} and σ_{(y)} by the equation (2) and an expected value of the entropy calculated from the estimated σ_{(y)} by the equation (4), similarly to the estimation unit 12 in the first embodiment.

The abnormality determination device 210 can be implemented by, for example, a computer 40 illustrated in FIG. 7. The storage unit 43 of the computer 40 stores an abnormality determination program 250 for causing the computer 40 to function as the abnormality determination device 210 to execute training processing and determination processing, which will be described below. The abnormality determination program 250 has an autoencoder process 260, an estimation process 252, an adjustment process 254, and a determination process 56.

The CPU 41 reads the abnormality determination program 250 from the storage unit 43, expands the abnormality determination program 250 on a memory 42, and sequentially executes the processes included in the abnormality determination program 250. The CPU 41 operates as the autoencoder 220 illustrated in FIG. 2 by executing the autoencoder process 260. Furthermore, the CPU 41 operates as the estimation unit 212 illustrated in FIG. 2 by executing the estimation process 252. Furthermore, the CPU 41 operates as the adjustment unit 214 illustrated in FIG. 2 by executing the adjustment process 254. Furthermore, the CPU 41 executes the determination process 56, thereby operating as the determination unit 16 illustrated in FIG. 2. With this configuration, the computer 40 that has executed the abnormality determination program 250 functions as the abnormality determination device 210.

Note that the functions implemented by the abnormality determination program 250 may also be implemented by, for example, a semiconductor integrated circuit, for example, an ASIC or the like.

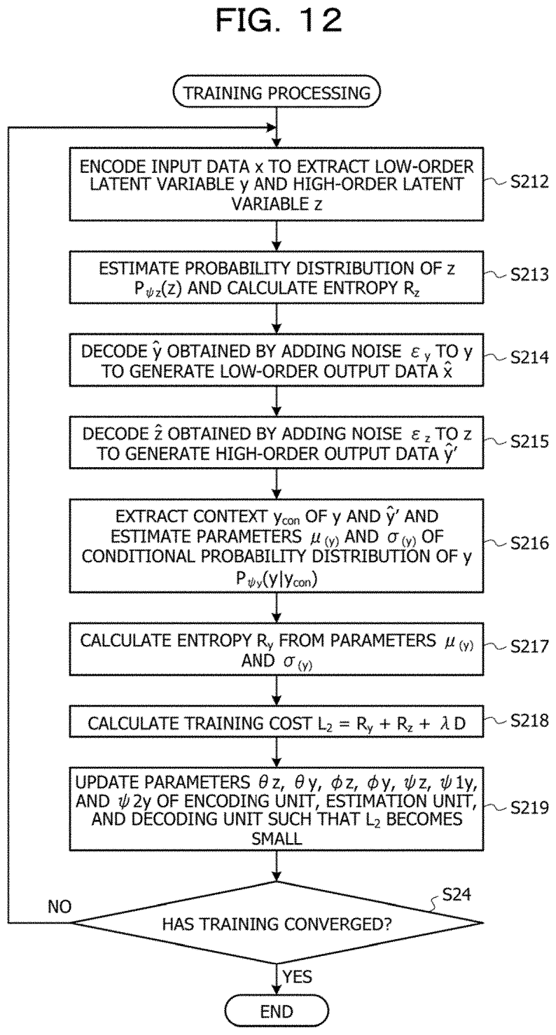

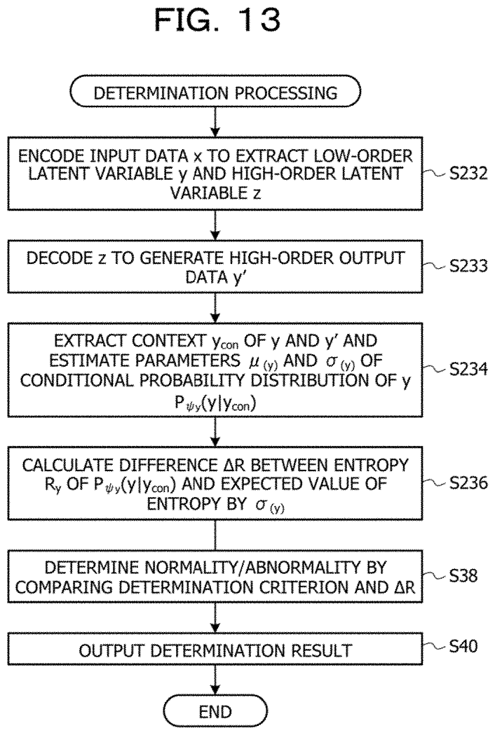

Next, function and operation of the abnormality determination device 210 according to the second embodiment will be described. When the input data x for training is input to the abnormality determination device 210 during adjustment of the parameters of the autoencoder 220 and the estimation unit 212, the abnormality determination device 210 executes training processing illustrated in FIG. 12. Furthermore, when the input data x to be determined is input to the abnormality determination device 210 during determination of normality or abnormality, the abnormality determination device 210 executes determination processing illustrated in FIG. 13.

First, the training processing will be described in detail with reference to FIG. 12.

In step S212, the low-order encoding unit 221 extracts the low-order latent variable y from the input data x using the encoding function f_{θy}(x) including the parameter θy, and outputs the low-order latent variable y to the low-order adding unit 225 and the high-order encoding unit 222. Furthermore, the high-order encoding unit 222 extracts the high-order latent variable z from the low-order latent variable y using the encoding function f_{θz}(y) including the parameter θz, and outputs the high-order latent variable z to the high-order adding unit 226.

Next, in step S213, the estimation unit 212 estimates the probability distribution P_{ψz}(z) of the high-order latent variable z using the GMM including the parameter ψz. Furthermore, the estimation unit 212 calculates the entropy R_{z}=−log(P_{ψz}(z)) of the probability distribution P_{ψz}(z).

Next, in step S214, the low-order noise generation unit 223 generates the noise ε_{y} that is a random number based on a Gaussian distribution in which the dimensionality is the same as that of the low-order latent variable y and the respective dimensions are uncorrelated with each other, and the mean is 0 and the variance is σ², and outputs the noise ε_{y} to the low-order adding unit 225. Then, the low-order adding unit 225 adds the low-order latent variable y input from the low-order encoding unit 221 and the noise ε_{y} input from the low-order noise generation unit 223 to generate the low-order latent variable y\hat{ } and outputs the low-order latent variable y\hat{ } to the low-order decoding unit 227. Moreover, the low-order decoding unit 227 decodes the low-order latent variable y\hat{ } using the decoding function g_{φy}(y\hat{ }) including the parameter φy to generate the low-order output data x\hat{ }.

Next, in step S215, the high-order noise generation unit 224 generates the noise ε_{z} that is a random number based on a Gaussian distribution in which the dimensionality is the same as that of the high-order latent variable z and the respective dimensions are uncorrelated with each other, and the mean is 0 and the variance is σ², and outputs the noise ε_{z} to the high-order adding unit 226. Then, the high-order adding unit 226 adds the high-order latent variable z input from the high-order encoding unit 222 and the noise ε_{z} input from the high-order noise generation unit 224 to generate the high-order latent variable z\hat{ }, and outputs the high-order latent variable z to the high-order decoding unit 228. Moreover, the high-order decoding unit 228 decodes the high-order latent variable z\hat{ } using the decoding function g_{φz}(z\hat{ }) including the parameter φz to generate the high-order output data y\hat{ }′.

Next, in step S216, the estimation unit 212 extracts context y_{con} from the low-order latent variable y and the high-order output data y\hat{ }′ using an extraction function h_{φ2y} including a parameter ψ2y. Then, the estimation unit 212 estimates parameters μ_{(y)} and σ_{(y)} of a conditional probability distribution P_{ψy} (y|y_{con}) of the low-order latent variable y under the context y_{con}, the conditional probability distribution being represented by a multidimensional Gaussian distribution, using an extraction function h_{ψ1y} including a parameter ψ1u.

Next, in step S217, the estimation unit 212 calculates the entropy R_{y}=−log(P_{ψy}(y|y_{con})) of the conditional probability distribution P_{ψy}(y|y_{con}) by the equation (2), using the estimated μ_{(y)} and σ_{(y)}.

Next, in step S218, the adjustment unit 214 calculates the error between the input data x and the output data x\hat{ } generated in step S214 above as, for example, D=(x−x\hat{ })². Then, the adjustment unit 214 calculates the training cost L₂ represented by the weighted sum of the calculated error D and the entropy R_{z} and the entropy R_{y} calculated in steps S213 and S217 above, as illustrated in the equation (7), for example.

Next, in step S219, the adjustment unit 214 updates the parameters such that the training cost L₂ becomes smaller. The parameters to be updated are the parameters θy, θz, φy, φz, ψz, ψ1y, and ψ2y of the low-order encoding unit 221, the high-order encoding unit 222, the low-order decoding unit 227, the high-order decoding unit 228, and the estimation unit 212.

Next, in step S24, the adjustment unit 214 determines whether the training has converged. In a case where the training has not converged, the processing returns to step S212, and the processing of steps S212 to S219 is repeated for the next input data x. In a case where the training has converged, the training processing ends.

Next, the determination processing will be described in detail with reference to FIG. 13. The determination processing is started in the state where each of the parameters θy, θz, φz, ψ1y, and ψ2y adjusted by the training processing is set in each of the low-order encoding unit 221, the high-order encoding unit 222, the high-order decoding unit 228, and the estimation unit 212.

In step S232, the low-order encoding unit 221 extracts the low-order latent variable y from the input data x using the encoding function f_{θy}(x) including the adjusted parameter θy, and outputs the low-order latent variable y to the low-order adding unit 225 and the high-order encoding unit 222. Furthermore, the high-order encoding unit 222 extracts the high-order latent variable z from the low-order latent variable y using the encoding function f_{θz}(y) including the adjusted parameter θz, and outputs the high-order latent variable z to the high-order adding unit 226.

Next, in step S233, the high-order decoding unit 228 decodes the high-order latent variable z using the decoding function g_{φz}(z) including the adjusted parameter φz to generate the high-order output data y′.

Next, in step S234 the estimation unit 212 extracts context yₐₘ from the low-order latent variable y and the high-order output data y′ using an extraction function h_{ψ2y} including a parameter ψ2y. Then, the estimation unit 212 estimates parameters μ_{(y)} and σ_{(y)} of a conditional probability distribution P_{ψy}(y|y_{con}) of the low-order latent variable y under the context y_{con}, the conditional probability distribution being represented by a multidimensional Gaussian distribution, using an extraction function h_{ψ1y} including a parameter ψ1y.

Next, in step S236, the estimation unit 212 calculates the difference ΔR between the entropy R_{y} calculated from the μ_{(y)} and σ_{(y)} estimated in step S234 above by the equation (2) and an expected value of the entropy calculated from the estimated σ_{(y)}, using the following equation (4).

Hereinafter, in steps S38 and S40, the determination unit 16 determines whether the input data x is normal or abnormal by comparing the entropy difference ΔR with a predetermined criterion, outputs a determination result, and terminates the determination processing, similarly to the first embodiment,

As described above, the abnormality determination device according to the second embodiment estimates the conditional probability distribution of the low-order latent variable under the context, further using the context based on the lower-dimensional high-order latent variable, the high-order latent variable being obtained by encoding the low-order latent variable. Then, the abnormality determination device determines whether the input data to be determined is normal, using the entropy of the estimated conditional probability distribution and the determination criterion. As a result, a broader feature can be used as the context and thus the normality or abnormality can be determined with more accuracy than the first embodiment.

Note that, in the above-described first embodiment, the noise ε added to the latent variable y to generate the latent variable y\hat{ } may be a uniform distribution U(−½, ½). Furthermore, in the above-described second embodiment, the noise ε_{y} added to the low-order latent variable y to generate the low-order latent variable y\hat{ } may be a uniform distribution U(−½, ½). In this case, the conditional probability distribution P_{ψy}(y|y_{con}) estimated during training is given by the following equation (8). Furthermore, the entropy difference ΔR calculated during estimation is given by the following equation (9). Note that C in the equation (9) is a constant empirically determined according to a designed model.

$$[ Math . 8 ]$$

$${P}_{ψ y} ( y \vert {y}_{con} ) = {\prod }_{i} ( N ( {μ}_{i ( y )} , {σ}_{i ( y )}^{2} ) * U ( - \frac{1}{2} , \frac{1}{2} ) ) ( {y}_{i} ) \qquad ( 8 )$$

$$Δ R = - log ( {P}_{ψ y} ( y \vert {y}_{con} ) ) - \frac{1}{2} {\sum }_{i} max ( log ( 2 {π e σ}_{i ( y )}^{2} ) - log ( \frac{π e}{6} \_ + C , 0 ) \qquad ( 9 )$$

Furthermore, in the above-described second embodiment, the case of estimating the probability distribution of the high-order latent variables by the GMM has been described, but the present embodiment is not limited to the case. For example, a method of expressing a cumulative probability function in the form of a composite function and estimating a probability distribution in which each dimension is independent as a derivative function group factorized by chain rule may be used.

Furthermore, in each of the above-described embodiments, the case where the input data is image data has been mainly illustrated, but the input data may be waveform data such as an electrocardiogram or an electroencephalogram. In that case, a one-dimensionally transformed CNN or the like may be used for an algorithm of encoding and the like.

Furthermore, in each of the above-described embodiments, a determination control device including each functional unit for training and determination has been described in one computer, but the present embodiment is not limited to the case. A training device including an autoencoder before parameter adjustment, an estimation unit, and an adjustment unit, and a determination device including an autoencoder with adjusted parameters, an estimation unit, and a determination unit may be respectively configured as separate computers.

Furthermore, while a mode in which the abnormality determination program is stored (installed) in the storage unit in advance has been described in each of the embodiments described above, the embodiments are not limited to this. The program according to the disclosed technique may be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an abnormality determination program for causing a computer to execute processing comprising:
estimating a low-dimensional feature quantity with a lower dimensionality than input data obtained by encoding the input data as a conditional probability distribution using a condition based on data in a peripheral area of data of interest in the input data; and
adjusting parameters of each of the encoding and the estimating and decoding of a feature quantity obtained by adding a noise to the low-dimensional feature quantity, based on a cost that includes output data obtained by the decoding, an error between the output data and the input data, and entropy of the conditional probability distribution, wherein,
in determining whether input data to be determined is normal using the adjusted parameters, the determination is performed based on the conditional probability distribution based on data of a peripheral area of the input data to be determined.

2. The non-transitory computer-readable recording medium according to claim 1, wherein the conditional probability distribution is estimated by further using, as the condition, high-order output data obtained by decoding a high-order low-dimensional feature quantity obtained by encoding the low-dimensional feature quantity and with a dimensionality lower than the low-dimensional feature quantity.

3. The non-transitory computer-readable recording medium according to claim 1, wherein the cost is a weighted sum of the error and the entropy, and the parameters are adjusted so as to minimize the cost.

4. The non-transitory computer-readable recording medium according to claim 1, wherein the noise is a random number based on a distribution in which respective dimensions are uncorrelated with each other and a mean is 0.

5. The non-transitory computer-readable recording medium according to claim 1, wherein the determination is executed by comparing a difference between the entropy of the conditional probability distribution for the input data to be determined and an expected value of entropy calculated using the parameters obtained during estimation of the conditional probability distribution with a determination criterion.

6. An abnormality determination device comprising:
a memory; and
a processor coupled to the memory and configured to:
estimate a low-dimensional feature quantity with a lower dimensionality than input data obtained by encoding the input data as a conditional probability distribution using a condition based on data in a peripheral area of data of interest in the input data; and
adjust parameters of each of the encoding and the estimating and decoding of a feature quantity obtained by adding a noise to the low-dimensional feature quantity, based on a cost that includes output data obtained by the decoding, an error between the output data and the input data, and entropy of the conditional probability distribution, wherein,
in determining whether input data to be determined is normal using the adjusted parameters, the processor performs the determination based on the conditional probability distribution based on data of a peripheral area of the input data to be determined.

7. The abnormality determination device according to claim 6, wherein the conditional probability distribution is estimated by further using, as the condition, high-order output data obtained by decoding a high-order low-dimensional feature quantity obtained by encoding the low-dimensional feature quantity and with a dimensionality lower than the low-dimensional feature quantity.

8. The abnormality determination device according to claim 6, wherein the cost is a weighted sum of the error and the entropy, and the parameters are adjusted so as to minimize the cost.

9. The abnormality determination device according to claim 6, wherein the noise is a random number based on a distribution in which respective dimensions are uncorrelated with each other and a mean is 0.

10. The abnormality determination device according to claim 6, wherein the processor executes the determination by comparing a difference between the entropy of the conditional probability distribution for the input data to be determined and an expected value of entropy calculated using the parameters obtained during estimation of the conditional probability distribution with a determination criterion.

11. An abnormality determination method comprising:
estimating a low-dimensional feature quantity with a lower dimensionality than input data obtained by encoding the input data as a conditional probability distribution using a condition based on data in a peripheral area of data of interest in the input data; and
adjusting parameters of each of the encoding and the estimating and decoding of a feature quantity obtained by adding a noise to the low-dimensional feature quantity, based on a cost that includes output data obtained by the decoding, an error between the output data and the input data, and entropy of the conditional probability distribution, wherein,
in determining whether input data to be determined is normal using the adjusted parameters, the determination is performed based on the conditional probability distribution based on data of a peripheral area of the input data to be determined.

12. The abnormality determination method according to claim 11,
wherein the conditional probability distribution is estimated by further using, as the condition, high-order output data obtained by decoding a high-order low-dimensional feature quantity obtained by encoding the low-dimensional feature quantity and with a dimensionality lower than the low-dimensional feature quantity.

13. The abnormality determination method according to claim 11,
wherein the cost is a weighted sum of the error and the entropy, and the parameters are adjusted so as to minimize the cost.

14. The abnormality determination method according to claim 11,
wherein the noise is a random number based on a distribution in which respective dimensions are uncorrelated with each other and a mean is 0.

15. The abnormality determination method according to claim 11,
wherein the determination is executed by comparing a difference between the entropy of the conditional probability distribution for the input data to be determined and an expected value of entropy calculated using the parameters obtained during estimation of the conditional probability distribution with a determination criterion.
